(19) United States
(12) Patent Application Publication
(10) Pub. No.: US 2024/0409161 A1
(43) Pub. Date: Dec. 12, 2024

(54) VEHICLE STRUCTURE

(71) Applicant: JAGUAR LAND ROVER LIMITED, Whitley, Coventry, Warwickshire (GB)

(72) Inventors: Niall SHIMMIN, Whitley, Coventry, Warwickshire (GB); Franco BOSIO, Whitley, Coventry, Warwickshire (GB); Thomas MARSHALL, Whitley, Coventry, Warwickshire (GB); Alex WATSON, Whitley, Coventry, Warwickshire (GB)

(21) Appl. No.: 18/701,908

(22) PCT Filed: Oct. 12, 2022
(86) PCT No.: PCT/EP2022/078437

§ 371 Date: Apr. 16, 2024

(30) Foreign Application Priority Data
Oct. 22, 2021 (GB) 2115222.8

(51) Int. Cl. B62D 21/15; B62D 25/02; H01M 50/242; H01M 50/249

(52) U.S. Cl. CPC B62D 21/157; B62D 25/025; H01M 50/242; H01M 50/249; H01M 2220/20

(57) ABSTRACT

A vehicle structure includes a power supply pack assembly and a body portion. The power supply pack assembly comprises a cross member and one or more pack modules of the power supply pack assembly supported on the cross member. The vehicle structure comprises a side impact system comprising a first sacrificial zone that extends laterally in an inboard direction with respect to the furthest outboard lateral extent of the cross member on a corresponding side of the power supply pack assembly, so that in the event of a side impact of sufficient force to the vehicle structure corresponding to the side of the body portion and corresponding side of the power supply pack assembly, the cross member is impacted prior to any exhaustion of the first sacrificial zone, such that the power supply pack assembly is displaced laterally relative to the body portion.

### TECHNICAL FIELD

The present disclosure relates to vehicles and vehicle structures and their designs as pertaining to managing side impact forces where a power supply pack assembly is provided.

### BACKGROUND

In vehicles which, for instance, use batteries or fuel cells for propulsion, it is important to protect pack modules (e.g. battery modules or fuel cell) associated with such propulsion systems from the effects of impacts including side impacts (e.g. in the event of a crash). It may be for instance that direct impact to the pack modules has the potential to give rise to hazards (e.g. leaking and/or venting of potentially harmful chemicals and/or fire). The need to protect the pack modules may place design constraints on the designs of vehicles and their sub-structures. For instance, the area occupied by pack modules may be made smaller than is ideally desirable and/or the strength and weight of components may be increased more than would otherwise be desired/required. It is therefore desirable to find solutions which allow both protection of the pack modules and enhanced design freedom.

It is an object of embodiments of the invention to at least mitigate one or more of the problems of the prior art.

### SUMMARY OF THE INVENTION

Aspects and embodiments of the invention provide a vehicle structure and a vehicle as claimed in the appended claims.

According to an aspect of the invention there is provided a vehicle structure comprising a power supply pack assembly and a body portion at least substantially above the power supply pack assembly,
wherein the power supply pack assembly comprises a cross member and one or more pack modules of the power supply pack assembly supported on the cross member.

According to another aspect of the invention there is provided a vehicle structure comprising a power supply pack assembly and a body portion at least substantially above the power supply pack assembly,
wherein the power supply pack assembly comprises a cross member and one or more pack modules of the power supply pack assembly supported on the cross member,
wherein further the vehicle structure comprises a side impact system comprising a first sacrificial zone substantially vertically aligned with and extending laterally outboard from a side of the body portion
and where further the first sacrificial zone extends laterally in an inboard direction with respect to the furthest outboard lateral extent of the cross member on a corresponding side of the power supply pack assembly, so that in the event of a side impact of sufficient force to the vehicle structure corresponding to the side of the body portion and corresponding side of the power supply pack assembly, the cross member is impacted prior to any exhaustion of the first sacrificial zone, such that the power supply pack assembly is displaced laterally relative to the body portion.

By providing a vehicle structure arranged such that in the event of a side impact of sufficient force, the power supply pack assembly will be displaced laterally (e.g. away from the side impact) relative to the body portion and the likelihood of potentially dangerous damage to the pack modules of the power supply pack assembly may be reduced. Further, this relative displacement may result in absorption of impact energy (e.g. in terms of forces required to create necessary deformations and displacements) which might otherwise be absorbed elsewhere in a manner more dangerous to occupants of the vehicle and/or the integrity of the pack modules. With the cross member and optionally at least part of the body portion having greater rigidity than the first sacrificial zone, the relative lateral positioning and extents of the cross member, body portion and first sacrificial zone may facilitate relative lateral displacement of the power supply pack assembly and body portion. Specifically, substantial force from the impact may be exerted first on the power supply pack assembly and only later (if at all) on the body portion. Further, because the power supply pack assembly is located at least substantially below the body portion, rather, for instance, than incorporated within or surrounded by it, there may be additional scope for the desired relative lateral displacement without impact/interference between the power supply pack assembly and the body portion.

In some embodiments the one or more pack modules are in a module region of the power supply pack and the cross member extends laterally outboard from the module region and defines the furthest outboard lateral extent of the power supply pack assembly on the corresponding side thereof. In this manner the side impact may impinge upon the cross member and thereby move the power supply pack without for instance directly impacting and deforming/damaging the module region. As will be appreciated, this arrangement may be mirrored in a lateral sense, such that the cross member extends laterally outboard of the power supply pack in both lateral directions, thereby providing the protection effect regardless of the side of the vehicle which is impacted.

In some embodiments the cross member comprises a bottom plate of the power supply pack assembly on which the module region is provided. In this manner the cross member may create an impact/deflection point at or below the lower extent of the module region, thereby potentially being more effective in protecting a greater proportion of the module region from side impacts. Additionally it may serve to at least partially protect the module region from below and support the module region thereon.

In some embodiments the power supply pack assembly comprises a safeguard region preserving member extending laterally outboard from the module region and defining a safeguard region between itself and the cross member. The safeguard region preserving member may, especially in combination with the cross member, serve to preserve the safeguard region from an impacting body and/or deformed/displaced components of the vehicle. The safeguard region itself may serve to space and protect the module region.

In some embodiments the lateral extent of the safeguard region preserving member in the outboard direction is less than that of the cross member.

In some embodiments the safeguard region preserving member comprises a top plate of the power supply pack assembly below which the module region is provided. In this way, and especially in combination with the cross member, it may be more effective in protecting a greater proportion of the module region from side impacts. It may also serve to at least partially protect the module region from above.

In some embodiments the safeguard region is configured at least substantially as a void. Thus, the void may serve to accommodate any object or material forced into it by the impact without necessarily damaging the module region. It may further be beneficial that there is nothing pre-existing in the void prior to the impact which might be forced into the module region.

In some embodiments the first sacrificial zone comprises a first crumple zone arranged to deform and/or displace.

In some embodiments the first crumple zone comprises a vehicle sill.

In some embodiments, in the event of a side impact of sufficient force, at least part of the first crumple zone is arranged to deform and/or displace laterally and consequently to expand vertically in a region between the power supply pack assembly and body portion, causing vertical displacement of the power supply pack assembly with respect to the body portion. The vertical displacement e.g. downwards may both serve to absorb impact energy and to further ensure adequate space for the relative lateral displacement of the power supply pack assembly without it impacting on other parts of the vehicle including for instance the body portion (which might cause damage to the module region).

In some embodiments the side impact system comprises a second sacrificial zone substantially vertically aligned with and extending laterally outboard from the corresponding side of the power supply pack assembly.

In some embodiments the second sacrificial zone comprises a second crumple zone arranged to deform and/or displace.

In some embodiments the second crumple zone comprises a vehicle rail.

In some embodiments the vehicle rail attaches the power supply pack assembly to the body portion.

In some embodiments the vehicle rail is arranged to rotate in a side impact of sufficient force, thereby accommodating the relative lateral displacement of the power supply pack assembly and the body portion without the connection it provides failing. If this connection were to fail it might allow the power supply pack assembly to become detached from the vehicle, thus it is preferable that it is arranged to rotate in order to accommodate the relative lateral displacement.

In some embodiments the connection between the body portion and the vehicle rail is proximate a top of the vehicle rail and the connection between the power supply pack assembly and the vehicle rail is proximate a bottom of the vehicle rail, thereby facilitating the rotation in the event of a side impact of sufficient force. That is, in view of the two attachment points being significantly spaced in terms of the vertical extent of the rail, lateral displacement of the power supply pack assembly with respect to the body portion will apply a greater torsional force tending to rotate the rail. Additionally, greater relative lateral displacement can be accommodated because rotation of the full height of the rail is available to accommodate this.

In some embodiments the lateral extent of the cross member is sufficient to accommodate the rotation of the vehicle rail in a manner such that the vehicle rail does not contact the module region as a consequence of its rotation. Thus for instance, in a fully rotated state (i.e. accommodating the maximum relative lateral displacement of the power supply pack assembly and body portion without detachment at the rail, the rail may be accommodated entirely within the safeguard region.

In some embodiments the side impact system is mirrored to the opposite side of the vehicle structure.

In some embodiments the vehicle structure is arranged such that at least part of a force associated with the side impact is transferred, via the relative displacement of the power supply pack assembly, to, and for absorption by, the mirrored side impact system on a non-impacted side of the vehicle structure. It may in particular be that the cross member (and even with sufficient force the safeguard region preserving member) via displacement in the impact tends to displace and/or deform the first and/or second sacrificial zones on the non-impacted side. In particular the rail on the non-impacted side may be rotated at least principally by force delivered by the cross member while performing its relative lateral displacement with respect to the body portion.

In some embodiments the vehicle structure comprises a vertical support connecting the power supply pack assembly to the body portion arranged to provide vertical support to the power supply pack assembly, wherein during a side impact of sufficient force, the vertical support is arranged to deform in a lateral direction in order to accommodate the relative lateral displacement of the power supply pack assembly without the connection it provides failing. The vertical supports (which may for instance be straps) may be provided a least in part to provide vertical support to the power supply pack assembly at one or more locations along its lateral extent, thereby potential preventing it from deflecting vertically (e.g. sagging). The vertical supports may be designed to be relatively weak in the lateral direction, to allow them to deform to accommodate the relative lateral displacement of the power supply pack assembly relative to the body portion, and yet relatively strong in the vertical direction to provide the vertical support. Additionally the provision of the vertical rails may allow other components of the vehicle structure (e.g. the rails) to be less rigid, in view of them then having a reduced responsibility to provide vertical support), potentially facilitating rigidity differences desirable in producing the relative lateral displacement discussed.

In some embodiments the power supply pack assembly is a battery pack assembly. The pack modules may in this case be battery modules. Alternative power supply pack assemblies are also however possible e.g. a fuel cell.

In some embodiments the body portion comprises part or all of a floor of the vehicle.

According to yet another aspect of the invention there is provided a vehicle comprising the vehicle structure of the aspect discussed above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 is a side view of a vehicle according to an embodiment of the invention;

FIG. 2 is a cross-sectional view of a vehicle structure prior to a side impact according to an embodiment of the invention;

FIG. 3 is a cross-sectional view of a vehicle structure during a side impact according to an embodiment of the invention; and

FIG. 4 is a cross-sectional view of a vehicle structure after a side impact according to an embodiment of the invention.

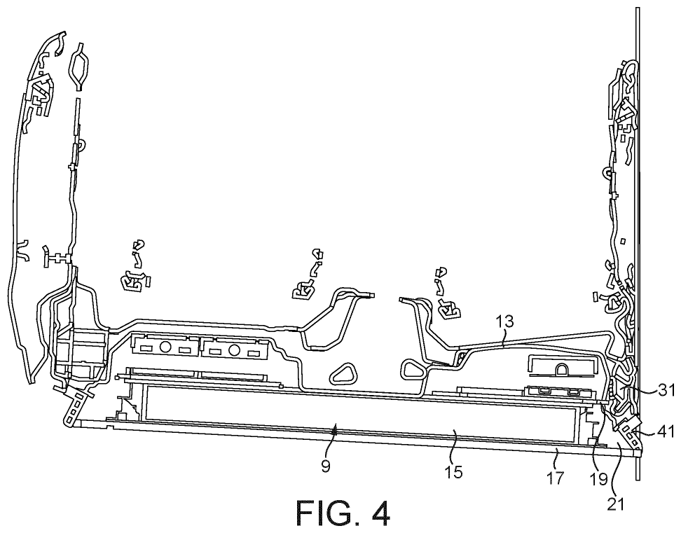

### DETAILED DESCRIPTION

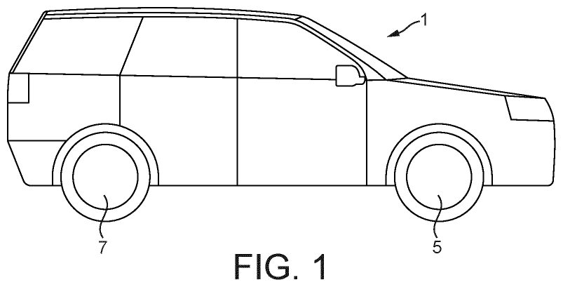

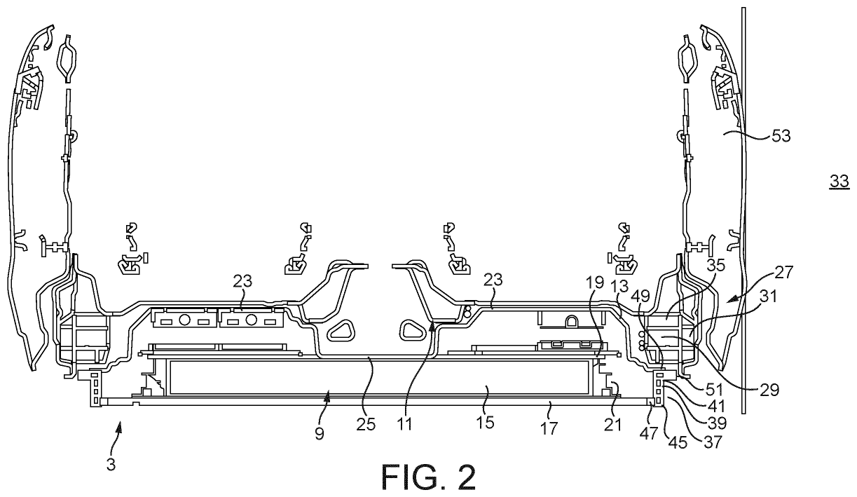

FIG. 1 shows a hybrid electric vehicle 1 which has a vehicle structure 3 shown in FIG. 2. The vehicle structure 3 forms a lower part of the vehicle 1 and may be generally characterised as corresponding to the floor and substructure of the vehicle 1 between its front 5 and rear 7 axles. The vehicle structure 3 has a power supply pack assembly (in this case a battery pack assembly generally shown at 9). It also has a body portion generally shown at 11 which in this embodiment is a floor 13 of the vehicle between the front 5 and rear 7 axles and extending between the sides of the vehicle 1.

The battery pack assembly 9 has a module region 15 containing the battery modules of the battery pack assembly 9. The module region 15 has a longitudinal extent that is substantially similar to the distance between the front 5 and rear 7 axles. Further, it has a lateral extent of between approximately 40% and 80% of the lateral extent (i.e. width) of the vehicle 1. Below and directly supporting the module region 15 is a cross member 17 constituted by a flat, rigid bottom plate. The cross member 17 has a lateral extent which exceeds that of the module region 15 to both of its sides, thereby extending outboard from the module region 15 and defining the outboard lateral extent of the battery pack assembly 9.

Directly above the module region 15 is a safeguard region preserving member 19 in the form of a flat, rigid top plate. The safeguard region preserving member 19 has a lateral extent which exceeds that of the module region 15, but is less than the lateral extent of the cross member 17 to both of its sides. A safeguard region (in this case a void 21) is defined between the safeguard region preserving member 19 and cross member 17 outboard from the module region 15.

The battery pack assembly 9 is substantially located below the level of the front 5 and rear 7 axles of the vehicle 1.

The floor 13 of the vehicle 1 is substantially above the battery pack assembly 9. The floor 13 is non-flat. In particular, the floor 13 is contoured, including to define elevated near and offside cabin floor areas 23 and a sunken central tunnel floor 25. The sunken central tunnel floor 25 is in contact with the safeguard region preserving member 19 of the battery pack assembly 9. The floor 13 and safeguard region preserving member 19 are connected by vertical supports (not shown). The floor thereby provides vertical support to the battery pack assembly 9.

The vehicle structure 3 also has a side impact system generally shown at 27.

The side impact system 27 has a first sacrificial zone 29 comprising voids and a first crumple zone 31. The first sacrificial zone 29 is provided so as to be substantially vertically aligned with and extending laterally outboard from the floor 13 on a side 33 of the vehicle 1. The first sacrificial zone 29 extends laterally in an inboard direction from the furthest outboard lateral extent of the cross member 17 of the battery pack assembly 9. The first crumple zone 31 is arranged to deform in a side impact of sufficient energy in order to absorb impact energy. The first crumple zone 31 includes a vehicle sill 35 running longitudinally with respect to the vehicle 1. In a side impact of sufficient force, the sill 35 is arranged to crumple in the lateral direction and expand in the vertical direction.

The side impact system 27 also has a second sacrificial zone 37. The second sacrificial zone 37 is provided substantially vertically aligned with and extending laterally outboard from the battery pack assembly 9 on the side 33. The second sacrificial zone 37 comprises a second crumple zone 39 arranged to deform in a side impact of sufficient energy in order to absorb impact energy. In this embodiment, the second crumple zone 37 includes a vehicle rail 41 of the vehicle 1 running longitudinally with respect to the vehicle 1. In a side impact of sufficient force, the vehicle rail 41 is arranged to be deformed and displaced.

The vehicle rail 41 has an inverted ‘L’ shaped cross-section. Further, in this embodiment, this cross section is consistent for substantially the full longitudinal extent of the vehicle rail 41. It is connected at its bottom 45 to the end 47 of the cross member 17. From that connection, the vehicle rail 41 extends substantially vertically upwards to its top 49. From there, it extends perpendicularly outboard to define an outboard rim 51 at its outer extent. Proximate its top 49, the vehicle rail 41 is connected with the floor 13.

The side impact system 27 as described above is mirrored on the opposite side of the vehicle structure 3.

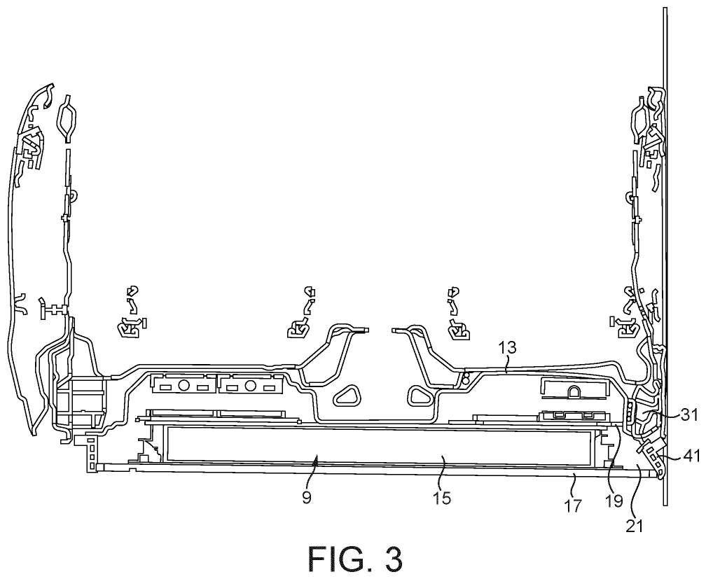

Referring now to FIG. 2 (during impact) and FIG. 3 (post impact), the effects of a side impact on the vehicle structure 3, and in particular the manner in which the vehicle structure 3 helps to protect the battery modules, are explained. In the example, the side impact is assumed to be with a relatively large and flat faced object (such as those used in mobile barrier and pole side impact tests for vehicles) and of sufficient force to produce the displacements and deformations described.

In the initial stages of the side impact, a door 53 of the vehicle 1 is partially crushed, including an area of the door vertically aligned with the first sacrificial zone 29. Thereafter, the first sacrificial zone 29 begins to be engaged by the impact and its first crumple zone 31 begins to be deformed. Before however the first crumple zone 31 is exhausted, the vehicle rail 41 and then the cross member 17 is engaged by the impact.

In view of the inverted ‘L’ shape of the vehicle rail 41, its initial contact with the forces of the impact is at the outboard rim 51, which tends to create a moment, rotating the vehicle rail 41 inwards above a pivot created by the connection between the vehicle rail 41 and the cross member 17. As the vehicle rail 41 rotates, it is accommodated in the void 21, which is sized to accommodate the rotation of the vehicle rail 41 without it fouling the module region 15.

The cross member 17 is the first member of substantial rigidity (i.e. not designed to substantially deform in an impact of sufficient force) encountered by the impacting body. As therefore the impact engages the cross member 17, it tends to laterally displace it in the direction of the impact. Further, because the remainder of the battery pack assembly 9 is rigidly attached to the cross member 17, it tends to be laterally displaced in a similar manner. Because however the first sacrificial zone 29 is not yet exhausted (i.e. is designed to continue to absorb energy by deformation) beyond the point at which the cross member 17 is engaged by the impact, the floor 13 does not (at least yet) experience the same degree of lateral force. Further, the rotation of the vehicle rail 41 and a relative weakness of the vertical supports in the lateral direction (which between them connect the battery pack assembly 9 to the floor 13) is conducive for the occurrence of relative lateral displacement of the battery pack assembly 9 and floor 13). Thus, as a consequence of the lateral force discrepancy and the nature of the connections, lateral displacement of the battery pack assembly 9 occurs relative to the floor 13 (and indeed remainder of the vehicle 1). It is noted that the nature of the connections between the battery pack assembly 9 and floor 13 may not only facilitate the relative lateral displacement, but also tend to allow for the maintenance of the connection between them despite the relative lateral displacement. This may advantageously reduce the likelihood of the battery pack assembly 9 becoming detached from the vehicle 1 during the impact.

The relative lateral displacement both moves the battery pack assembly 9 (and therefore the battery modules) so as to tend to maintain a distance from the impacting body and also absorbs energy from the impact. One element of this energy absorption is the deformation of the mirrored elements of the side impact system 27 on the non-impacted side of the vehicle structure 3. Specifically, the lateral displacement of the cross member 17 tends to cause the vehicle rail on the non-impacted side of the vehicle system 3 to rotate inwards about it.

As the impact progresses further, more of the first crumple zone 31 is exhausted as the battery pack assembly 9 is laterally displaced. Ultimately, especially as the first crumple zone 31 is exhausted, the floor 13 and/or the safeguard region preserving member 19 may experience greater lateral force associated with the impact. The safeguard region preserving member 19 may also be rigid and may assist in protecting the battery modules from any collapse of structure (e.g. from the first crumple zone 31) into the module region 15. Additionally, safeguard region preserving member 19 may also assist in transferring energy to the side impact system elements on the non-impacted side of the vehicle structure 3 (e.g. the first crumple zone on the non-impacted side).

In addition to the above effects, the first crumple zone 31 is arranged such that as it is crushed in the lateral direction, it expands in the vertical direction. This tends to force a degree of separation of the floor 13 and battery pack assembly 9 (i.e. forcing the battery pack assembly 9 downwards with respect to the floor). This may be beneficial, giving a greater degree of clearance between the battery pack assembly 9 and other parts of the vehicle structure 3 to accommodate the relative lateral displacement of the battery pack assembly 9 (potentially therefore reducing the risk of damage to the battery modules).

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features. By way of example, the power supply pack assembly need not be a battery pack assembly, but might instead be an alternative power supply source such as a fuel cell. Additionally, the vehicle structure may be provided in an alternative location within the vehicle e.g. aft of the rear axle or forward of the forward axle. By way of still further example, whilst in the embodiment discussed above, a hybrid electric vehicle is discussed, alternatives are possible, e.g. a fully electric vehicle.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A vehicle structure comprising a power supply pack assembly and a body portion at least substantially above the power supply pack assembly,
wherein the power supply pack assembly comprises a cross member and one or more pack modules of the power supply pack assembly supported on the cross member,
wherein further the vehicle structure comprises a side impact system comprising a first sacrificial zone substantially vertically aligned with and extending laterally outboard from a side of the body portion
and where further the first sacrificial zone extends laterally in an inboard direction with respect to the furthest outboard lateral extent of the cross member on a corresponding side of the power supply pack assembly, so that in the event of a side impact of sufficient force to the vehicle structure corresponding to the side of the body portion and corresponding side of the power supply pack assembly, the cross member is impacted prior to any exhaustion of the first sacrificial zone, such that the power supply pack assembly is displaced laterally relative to the body portion.

2. The vehicle structure according to claim 1 where the one or more pack modules are in a module region of the power supply pack assembly and the cross member extends laterally outboard from the module region and defines the furthest outboard lateral extent of the power supply pack assembly on the corresponding side thereof.

3. The vehicle structure according to claim 2 where the cross member comprises a bottom plate of the power supply pack assembly on which the module region is provided.

4. The vehicle structure according to claim 2 where the power supply pack assembly comprises a safeguard region preserving member extending laterally outboard from the module region and defining a safeguard region between itself and the cross member.

5. The vehicle structure according to claim 4 where the lateral extent of the safeguard region preserving member in the outboard direction is less than that of the cross member.

6. The vehicle structure according to claim 4 where the safeguard region preserving member comprises a top plate of the power supply pack assembly below which the module region is provided.

7. The vehicle structure according to claim 4 where the safeguard region is configured at least substantially as a void.

8. The vehicle structure according to claim 1 where the first sacrificial zone comprises a first crumple zone arranged to deform and/or displace.

9. The vehicle structure according to claim 8 where the first crumple zone comprises a vehicle sill.

10. The vehicle structure according to claim 8 where in the event of a side impact of sufficient force, at least part of the first crumple zone is arranged to deform and/or displace laterally and consequently to expand vertically in a region between the power supply pack assembly and body portion, causing vertical displacement of the power supply pack assembly with respect to the body portion.

11. The vehicle structure according to claim 1 where the side impact system comprises a second sacrificial zone substantially vertically aligned with and extending laterally outboard from the corresponding side of the power supply pack assembly.

12. The vehicle structure according to claim 11 where the second sacrificial zone comprises a second crumple zone arranged to deform and/or displace.

13. The vehicle structure according to claim 12 where the second crumple zone comprises a vehicle rail.

14. The vehicle structure according to claim 13 where the vehicle rail attaches the power supply pack assembly to the body portion.

15. The vehicle structure according to claim 13 where the vehicle rail is arranged to rotate in a side impact of sufficient force, thereby accommodating relative lateral displacement of the power supply pack assembly and the body portion without a connection it provides failing.

16. The vehicle structure according to claim 15 where a connection between the body portion and the vehicle rail is proximate a top of the vehicle rail and a connection between the power supply pack assembly and the vehicle rail is proximate a bottom of the vehicle rail, thereby facilitating the rotation of the vehicle rail in the event of a side impact of sufficient force.

17. The vehicle structure according to claim 15 wherein:
the one or more pack modules are in a module region of the power supply pack assembly and the cross member extends laterally outboard from the module region and defines the furthest outboard lateral extent of the power supply pack assembly on the corresponding side thereof; and
the lateral extent of the cross member is sufficient to accommodate the rotation of the vehicle rail in a manner such that the vehicle rail does not contact the module region as a consequence of its rotation.

18. The vehicle structure according to claim 1 where the side impact system is mirrored to the opposite side of the vehicle structure, and the vehicle structure is arranged such that at least part of a force associated with the side impact is transferred, via relative displacement of the power supply pack assembly, to, and for absorption by, the mirrored side impact system on a non-impacted side of the vehicle structure.

19. (canceled)

20. The vehicle structure according to claim 1 comprising a vertical support connecting the power supply pack assembly to the body portion arranged to provide vertical support to the power supply pack assembly, wherein during a side impact of sufficient force, the vertical support is arranged to deform in a lateral direction in order to accommodate relative lateral displacement of the power supply pack assembly without a connection it provides failing.

21. (canceled)

22. (canceled)

23. A vehicle comprising the vehicle structure according to claim 1.
